(19) United States
(12) Patent Application Publication
(10) Pub. No.: US 2013/0018519 A1
(43) Pub. Date: Jan. 17, 2013

(54) NETWORK POWER SUPPLY CONTROL SYSTEM, NETWORK POWER SUPPLY EQUIPMENT AND NETWORK POWER DEVICE THEREOF

(71) Applicant: Yu-Shiang LIN, Nantou County (TW)

(72) Inventor: Yu-Shiang LIN, Nantou County (TW)

(21) Appl. No.: 13/546,262

(22) Filed: Jul. 11, 2012

(30) Foreign Application Priority Data
Jul. 12, 2011 (TW) 100124563

(51) Int. Cl. G06F 1/26

(52) U.S. Cl. 700/295

(57) ABSTRACT

A network power supply control system is applicable to a network power supply equipment (PSE) and a network power device (PD) connected through a network cable. A signal generator is disposed on the network PSE for generating and combining an operating signal with a power signal provided by the network PSE. A signal analyzer is disposed on the network PD for extracting the operating signal from the power signal received by the network PD and controlling a load circuit of the network PD according to the operating signal. Alternatively, the signal generator is disposed on the PD and sends a operating signal according to a state of the load circuit and combines the operating signal with a return power signal returned by the network PD, and the signal analyzer is disposed on the PSE for extracting the operating signal from the return power signal received by the network PSE.

### CROSS-REFERENCE TO RELATED APPLICATION

This application claims the benefit of Taiwan Patent Application No. 100124563, filed on Jul. 12, 2011, which is hereby incorporated by reference for all purposes as if fully set forth herein

### BACKGROUND OF THE INVENTION

1. Field of Invention

The present invention relates to a network power supply control system, and more particularly to a network power supply control system for controlling an operation and a state of a network power device corresponding to changes of a power signal.

2. Related Art

The Power over Ethernet (PoE) technology is often used in a network system. The system includes two network equipments connected through a network cable: one is the network power supply equipment (PSE) and the other is a network power device (PD). The network power supply equipment transfers sufficient power to the network power device through a network cable for the operation of the power device. In the process, the network power supply equipment is also connected to the network power device through a network cable for performing transmission of packet data.

However, the PoE system is not applicable in the following situations. First, it is not applicable when the network power device is a dump device, that is, a network device for merely receiving data or instructions, or a network device that has no central processing unit (CPU) or micro processing unit (MPU). The network power supply equipment cannot detect whether or not the network power device has actually obtained the data transferred by the network power supply equipment, and cannot detect whether or not the network power device operates according to the instruction of the network power supply equipment. Secondly, when the network power device fails during operation (for example, shutdown where the network power device, cannot receive the packet or instruction to perform relevant operation), the network power supply equipment cannot detect the operation of the network power device. Moreover, the network power supply equipment transfers power to the network power device through the network cable. Once the network power device is broken down, the network power supply equipment cannot detect whether or not the transferred power is utilized by the network power device, so the power is wasted. Thirdly, in the situation that multiple network power devices are connected to the network power supply equipment through a one-to-multiple device (such as a switch, a router and an intelligent hub), once the network power supply equipment remotely resets one of the electronic devices and cuts off the power of the electronic device and then re-powers the electronic device, the network power supply equipment can only cut off the power supply. All the electronic devices connected to the switch are subject to the power reset operation accordingly, which influences the stability and work fluency of the whole system. Fourthly, when the network power supply equipment and the network power device adopt different network protocols, or data recognition formats used by upper layer application software of the network power supply equipment and the network power device are different, as in the network architecture, a closed path is formed on the first layer and the second layer, while an open path is formed on the third layer because data recognition is not completed, such that the network power device cannot recognize the control command of the network power supply equipment, and is not controlled by the network power supply equipment.

Therefore, the issue of how to enable the network power supply equipment to actually control the operation of the network power device or actually obtain a response of the network power device to actually form a real connection between the network power supply equipment and the network power device becomes a problem that manufacturers and the field need to consider.

### SUMMARY OF THE INVENTION

The embodiments are directed to a network power supply control system and electronic devices used in the system, so as to enable a network power supply equipment to actually control an operation or a state of a network power device.

In order to solve the system problems, one embodiment provides a network power supply control system, which is applicable to a network power supply equipment and a network power device connected through a network cable. The system comprises a signal generator and a signal analyzer.

The signal generator is used for generating an operating signal. The operating signal is combined with a power signal transferred through the network cable. The signal analyzer is used for analyzing the power signal through the network cable to extract the operating signal.

Therefore, each embodiment is characterized in that the original PoE system does not need to be greatly changed according to the present invention. Some electronic control elements are used to control the rise and drop of the level of the power signal, and the operating signal is combined with the power signal. Secondly, when the network power device is a dump device, that is, a network device for merely receiving data or instructions, or a network device having no PCU or MPU, the network power supply equipment can still control the operation of the network power device through the technology disclosed in the present invention, or obtain an operation state of the network power device. Thirdly, in the situation that multiple network power devices are connected to the network power supply equipment through a one-to-multiple device, through the technology disclosed in the present invention, the network power supply equipment can merely perform power rest operation on one of the network power devices without affecting the other network power devices connected to the one-to-multiple device, which facilitates to maintain the stability and work fluency of the whole network system. Fourthly, even in the situation that the network power supply equipment and the network power device adopt different network protocols, or data recognition formats used by upper layer (that is, the third layer and above) application software of the network power supply equipment and the network power device are different, so the data recognition cannot be completed and an open path is formed, because a closed path is formed on the first layer and the second layer, the network power supply equipment can also control an operation and a state of the network power device through the changes of the power signal. Therefore, regardless of the state or the type of the network power device, the network power supply equipment can perform a certain extent of control and management on the network power device, thereby improving the convenience and applicability of the network management operation.

### BRIEF DESCRIPTION OF THE DRAWINGS

The present invention will become more fully understood from the detailed description given herein below for illustration only, and thus are not limitative of the present invention, and wherein:

FIG. 1 is a first schematic system block diagram of a network power supply system according to an embodiment of the present invention;

FIG. 2A is a partial DC_Disconnect equivalent circuit diagram of a first network power supply equipment of a network power supply system according to an embodiment of the present invention;

FIG. 2B is a schematic view of a DC power signal of a network power supply system according to an embodiment of the present invention;

FIG. 3 is a partial equivalent circuit diagram of a first network power device of a network power supply system according to an embodiment of the present invention;

FIG. 4A is a partial AC_Disconnect equivalent circuit diagram of a first network power supply equipment of a network power supply system according to an embodiment of the present invention;

FIG. 4B is a schematic view of an AC power signal of a network power supply system according to an embodiment of the present invention;

FIG. 5 is a second schematic system block diagram of a network power supply system according to an embodiment of the present invention;

FIG. 6A is a partial equivalent circuit diagram of a second network power device of a network power supply system according to an embodiment of the present invention;

FIG. 6B is a schematic view of a return power signal of a network power supply system according to an embodiment of the present invention; and

FIG. 7 is a partial AC equivalent circuit diagram of a second network power supply equipment of a network power supply system according to an embodiment of the present invention, in which merely AC_Disconnect is taken as an example.

### DETAILED DESCRIPTION OF THE INVENTION

The preferred embodiments of the present invention are illustrated in detail below with reference to the accompanying drawings.

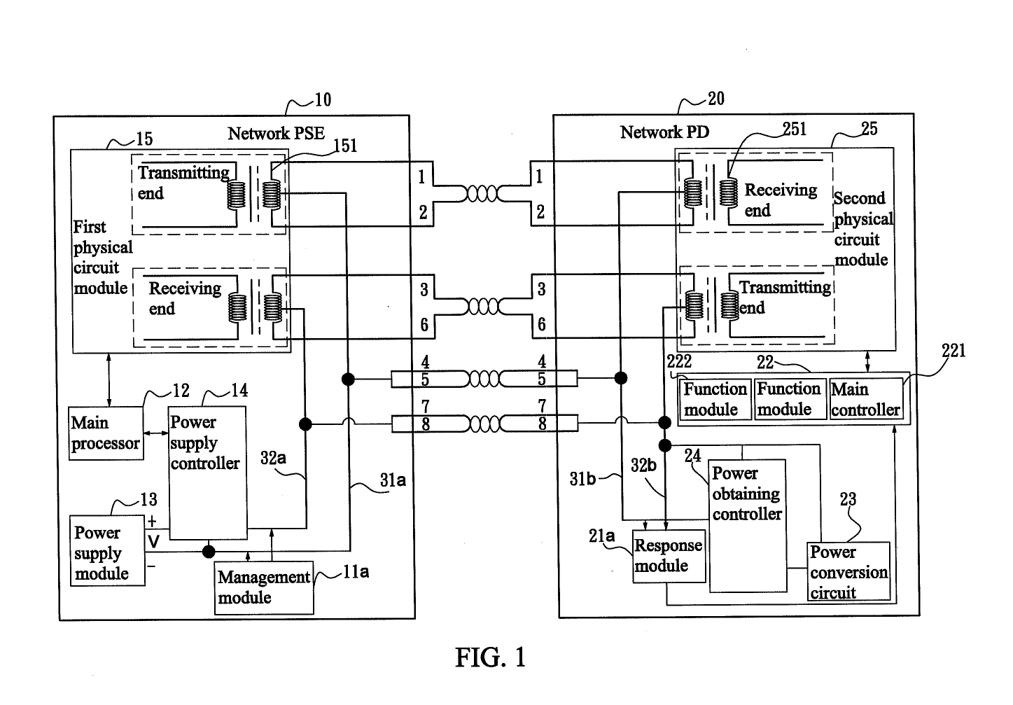

FIG. 1 is a first schematic system block diagram of a network power supply system according to an embodiment of the present invention. Referring to FIG. 1, the system is applicable in two network equipments connected through a network cable: one is a network power supply equipment 10 and the other is a network power device 20, which are connected to each other through a network cable (illustrated with RJ-45 specification), and each equipment meets the specification of Institute of Electrical and Electronics Engineers (IEEE)-802.3. The above specifications of equipment and network cable are merely examples for descriptions, but not limited thereto. In this embodiment, the network cable has eight lines, in which a pin 1 and a pin 2 of the network cable is used by the network power supply equipment 10 to transfer data to the network power device 20, a pin 3 and a pin 6 of the network cable are used by the network power device 20 to transfer data to the network power supply equipment 10.

Similarly, the equipment having Auto MDI/MDIX may also be used to implement the present invention. Alternatively, a pin 4 and a pin 5, and a pin 7 and a pin 8 are also used to implement the present invention. Alternatively, any two pairs of lines having power transferred thereon, that is, the equipment at two ends of the network cable have the same agreement and use specific paired pins to transfer data, can also be used to implement the present invention.

The network power supply equipment 10 includes a management module 11a, a network power supply module and a main processor 12. In this embodiment, the management module 11a has a capability of a signal generator. The network power supply module includes a power supply module 13, a power supply controller 14 and a first physical circuit module 15. The first physical circuit module 15 includes a transmitting end and a receiving end, and is disposed with two transmission transformers 151. The transmission transformers 151 are disposed at the transmitting end (a line 1 and a line 2) and the receiving end (a line 3 and a line 6) of the network power supply equipment 10. The power supply module 13 is connected to the power supply controller 14, and then is electrically connected to the transmitting end and the receiving end of the first physical circuit module 15 through the power supply controller 14. The main processor 12 is connected to the power supply controller 14 and the first physical circuit module 15, and is used for providing packet data or instructions for transmission, analyzing the received packet data, and controlling the operation of the power supply controller 14.

When the main processor 12 starts the power supply controller 14, the power supply controller 14 enables to form an electrical connection between the power supply module 13 and the first physical circuit module 15, and the power supply module 13 provides a power signal to a central position of an induction coil of the transmission transformer 151. The first physical circuit module 15 mixes digital data or an operating signal that the main processor 12 intends to provide to the network power device 20 with the power signal, and transfers the mixture of the digital data and the power signal or the mixture of the operating signal and the power signal to the network power device 20 without interfering with the data transmission.

The network power device 20 includes a response module 21a, a network power obtaining module and a load circuit 22. In this embodiment, the response module 21a has a capability of a signal analyzer. The load circuit 22 includes a main controller 221 and relevant function modules 222. The network power obtaining module includes a power obtaining controller 24 and a second physical circuit module 25. The second physical circuit module 25 includes a transmitting end and a receiving end, and is disposed with two transmission transformers 251. The power obtaining controller 24 is electrically connected to the transmitting end and the receiving end of the second physical circuit module 25. The two transmission transformers 251 are disposed at the transmitting end (a line 3 and a line 6) and the receiving end (a line 1 and a line 2) of the network power device 20 to sense the power signal sent by the network power supply equipment 10 and provide the power signal to a power conversion circuit 23 disposed in the network power device 20. The power conversion circuit 23 converts the power signal into the working power required by the network power device 20 for the operation of the network power device 20. The main controller 221 is connected to the second physical circuit module 25, and is used for analyzing the received packet data or instructions to enable the function modules 222 to perform corresponding operations.

As shown in FIG. 1, the management module 11a is electrically connected to the network power supply module. The management module 11a is electrically connected to a line between the power supply controller 14 and the first physical circuit module 15.

The management module 11a may be controlled by the main processor 12 or a man-machine interface of the network power supply equipment 10, and the man-machine interface may be a software control interface, a hardware panel or a switching element of the network power supply equipment 10, which is not limited in terms of design.

When the management module 11a is started, the management module 11a is controlled by the main processor 12 or the man-machine interface according to a preset operation mode to generate an operating signal and combine the operating signal with a power signal. The power signal is transferred to the network power device 20 through the network cable connected to the network power supply module.

As shown in FIG. 1, the response module 21a is electrically connected to the network power obtaining module and the load circuit 22. The response module 21a is electrically connected to a line between the power obtaining controller 24 and the second physical circuit module 25. The response module 21a is used for analyzing the power signal obtained by the network power obtaining module through the network cable, extracting the operating signal, and controlling an operation of the load circuit 22 according to an instruction of the operating signal. For example, an instruction is delivered to the main controller 221 to enable the main controller 221 to control operations of the function modules 222. If the equipment does not have the controller, the function modules 222 or relevant circuits and elements may be directly controlled, so as to directly control the overall operation of the network power device 20. Furthermore, the response module 21 a may be electrically connected to the power obtaining controller 24, so that a power reset function of the power obtaining controller 24 may be triggered when the operating signal is obtained, so as to re-start the network power device 20 or generate another operating signal to control the operation of the network power device 20.

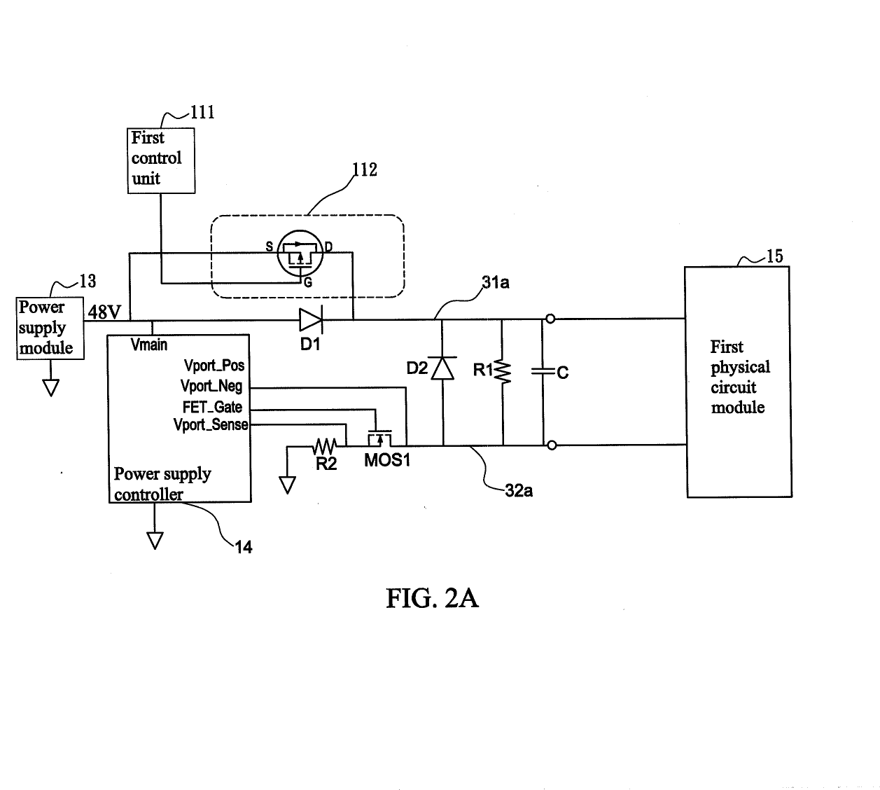

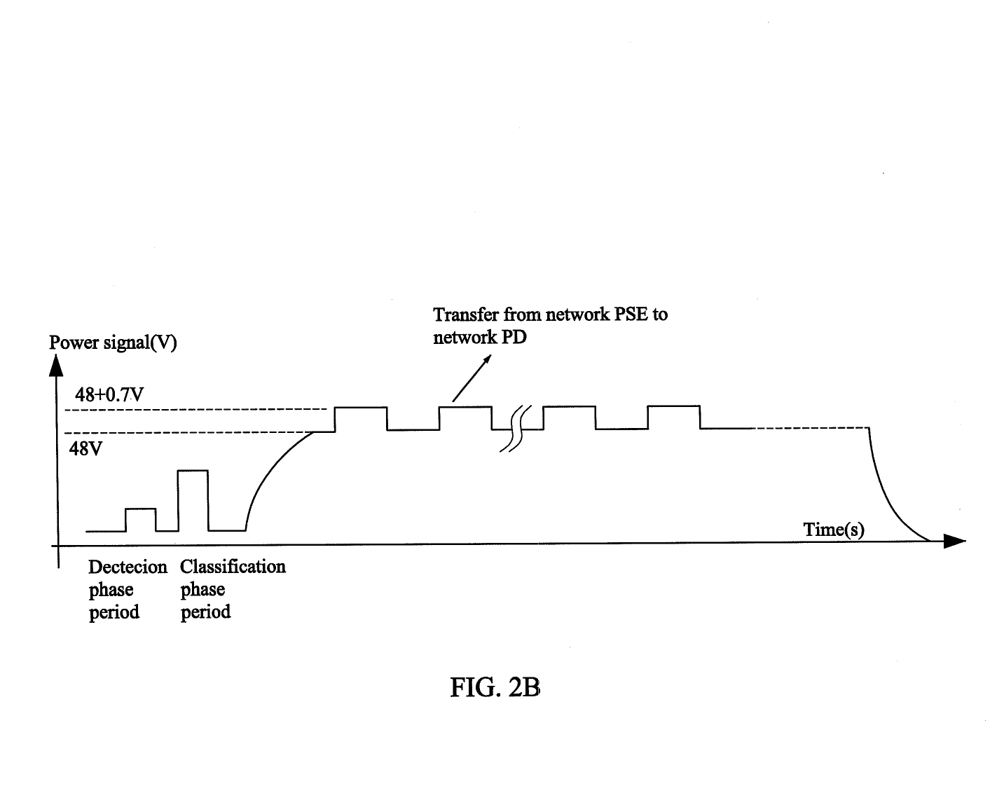

As described above, PoE architectures include DC_Disconnect (a DC power type) and AC_Disconnect (an AC power type). The implementation of the present invention is adaptive to and does not conflict with the two types of PoE architectures. FIG. 2A is a partial DC_Disconnect equivalent circuit diagram of a first network power supply equipment of a network power supply system according to an embodiment of the present invention. FIG. 2B is a schematic view of a DC power signal of a network power supply system according to an embodiment of the present invention. For the ease of understanding, reference can be made to the first system block diagram in FIG. 1.

In the power supply module 13, a power supply signal of 48 volts (v) is taken as an example. The power supply controller 14 includes a main power supply pin (Vmain), a positive electrode pin (Vport_Pos), a negative electrode pin (Vport_Neg), a transistor gate control pin (FET-Gate), a power sense pin (Vport_Sense) and a ground. A circuit structure connected to the power supply controller 14 includes a first diode D1, a second diode D2, a first resistor R1, a capacitor C, a first field effect transistor MOS1 and a second resistor R2. The Vmain is electrically connected to the power supply module 13 and an anode (or P-electrode) of the first diode D1 and a cathode (or N-electrode) of the first diode D1 is connected to a positive line (Pos_Line) 31a. The negative electrode pin (Vport_Neg) of the power supply controller 14 is connected to a negative line (Neg_Line) 32a. A drain of the first field effect transistor MOS 1 is also connected to the negative line 32a, and a gate is connected to the transistor gate control pin (FET-Gate). A buffer circuit formed with the second diode D2, the first resistor R1 and the capacitor C connected in parallel is bridged between the positive line 31a and the negative line 32a. A power sense pin (Vport_Sense) is connected to a source of the first field effect transistor MOS1 and the second resistor R2. The ends of the positive line 31a and the negative line 32a are connected to the transmission transformer 151 of the first physical circuit module 15. The above circuit structure is merely an example for description, but the present invention is not limited thereto.

The diodes may be replaced by other elements that can be turned on at a forward voltage and be turned off at a reverse voltage, but the present invention is not limited to diodes. The field effect transistors may be replaced by other controllable switching elements, but the present invention is not limited to the field effect diodes.

The management module 11a includes a control unit and a signal generation unit 112 connected to the control unit. In order to distinguish the control unit of the management module from the control unit of the network power device 20 below, the control unit of the management module 11a is referred to as a first control unit 111. The first control unit 111 may be, but is not limited to, an MPU, a micro control unit (MCU) or other relevant types of computing or control elements. The type of the elements of the signal generation unit is not limited, and is determined according to demands of a designer, and herein, the field effect transistor is taken as an example for description.

A drain and a source of the signal generation unit 112 are connected to two ends of the first diode D1, and the first control unit 111 is connected to a gate of the signal generation unit 112. The first control unit 111 is electrically connected to the main processor 12 or the man-machine interface described above, and is controlled by the main processor 12 or the man-machine interface to control to form a closed path or an open path of the signal generation unit 112, thereby generating the operating signal. In this example, the operating signal is a signal having changes at a voltage level, and according to the properties of the field effect transistor, the changes at the voltage level of the operating signal is about 0.7V. Herein, the designer may preset the operating signal as a digital instruction formed by numeric values 0 and 1. 0 corresponds to a low voltage of the voltage level, and 1 corresponds to a high voltage of the voltage level. Alternatively, 0 corresponds to a high voltage of the voltage level, and 1 corresponds to a low voltage of the voltage level, which depends on the demands of the designer.

However, for the voltage and the current when the power signal and the operating signal are being combined, the maximal values and the minimal values need to meet the specification of IEEE-802.3. Besides the field effect transistor, the signal generation unit 112 may also be a relay or other types of transistors, for example, a bipolar junction transistor (BJT) or other electronic elements having the switching property or power control capability.

However, the power signal is modulated by the transmission transformers of the first physical circuit module 15 and forms a power specification of power transferable on a network cable. The transmission transformers of the second physical circuit module 25 modulate the power transferred through the network cable again to form the original power signal. The power specification conversion technology is well known to persons of ordinary skill in the field of the PoE system technology, and will not be repeated herein, which is illustrated below in cooperation with the power signal.

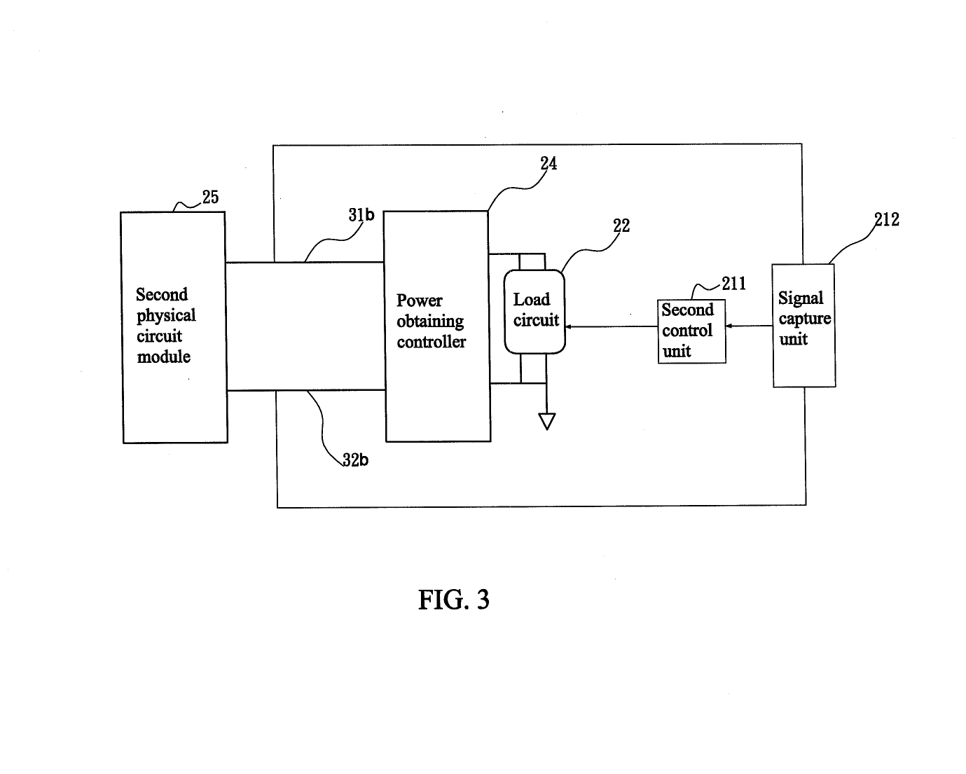

FIG. 3 is a partial equivalent circuit diagram of a first network power device of a network power supply system according to an embodiment of the present invention. Referring to FIG. 3 together with FIG. 1, the response module 21a includes a control unit and a signal capture unit 212. In order to distinguish the control unit of the response module from the control unit described above, the control unit of the response module is referred to as a second control unit 211. The signal capture unit 212 is connected to a circuit between the second physical circuit module 25 and the power obtaining controller 24 (including a positive line 31b and a negative line 32b) and is used for sensing and capturing the power signal. The second control unit 211 is connected to the signal capture unit 212 and the load circuit 22, and is used for analyzing the power signal obtained by the signal capture unit 212, extracting the operating signal from the power signal, and controlling operation of the load circuit 22 according to the operating signal.

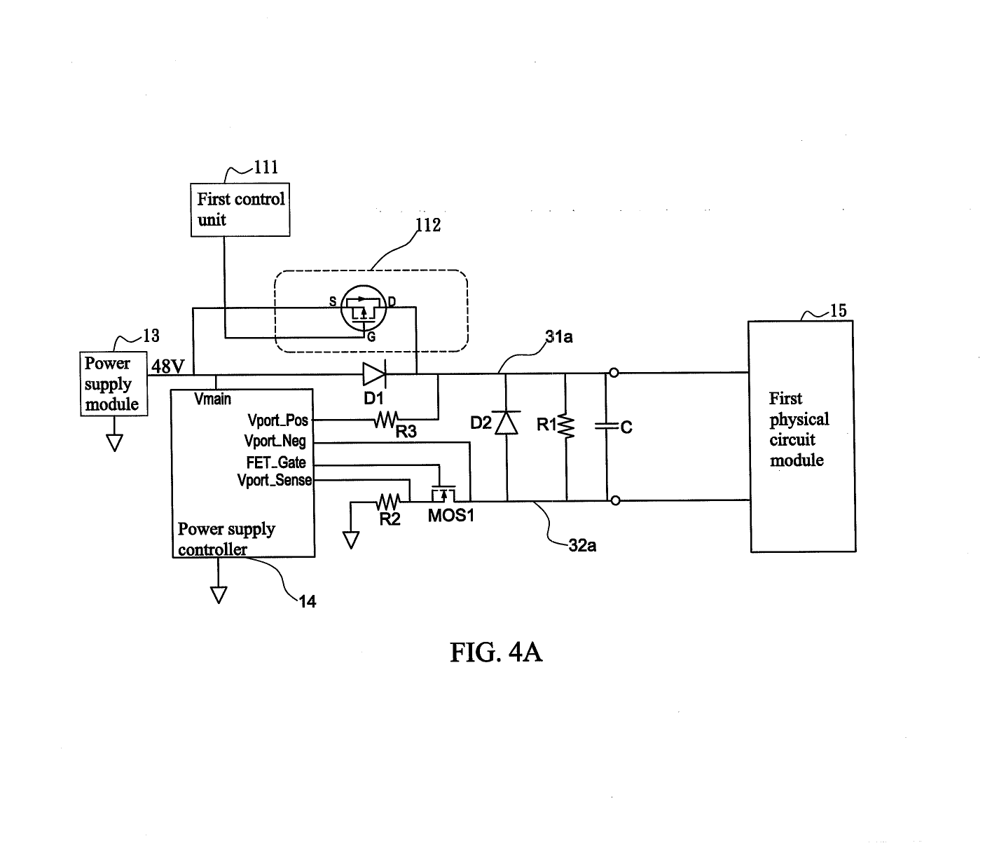

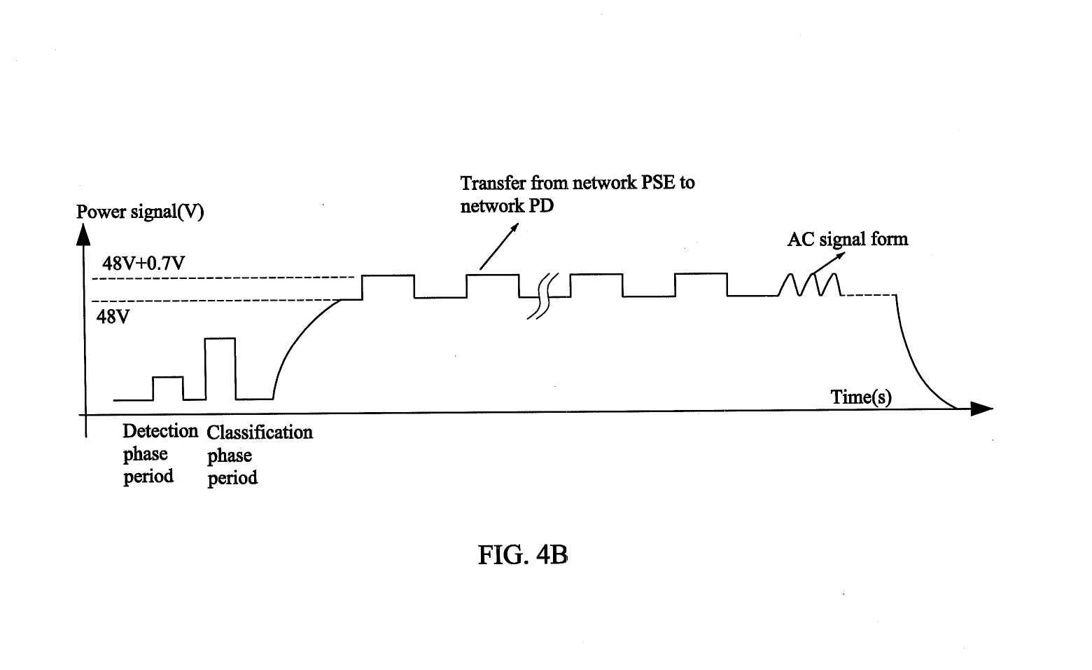

FIG. 4A is a partial AC_Disconnect equivalent circuit diagram of a first network power supply equipment of a network power supply system according to an embodiment of the present invention. FIG. 4B is a schematic view of an AC power signal of a network power supply system according to an embodiment of the present invention. For ease of understanding, reference can be made to the first system block diagram in FIG. 1. A difference between FIG. 2A and FIG. 4A lies in that, two ends of a third resistor R3 are respectively connected to the positive electrode pin (Vport_Pos) of the power supply controller 14 and the cathode of the first diode D1. The third resistor R3, the power supply controller 14 and the first diode D1 provide an AC signal on the positive line 31a. The power supply controller 14 determines whether the network power device 20 is normally connected to the network power supply equipment 10 through the network cable according to an AC impedance of the positive line 31a. If the AC impedance is within the specification defined in the IEEE-802.3 or the specification range agreed by the equipments, the power supply controller 14 continues to supply the power signal to the network power device 20. The power signal is then used to be combined with the operating signal, and the form of the formed signal is as shown in FIG. 4B. The power supply controller 14 controls the power supply signal of the third resistor R3, so that the mixed signal formed by combining the power signal and the operating signal is converted into an AC signal form. Accordingly, the signal capture unit 212 should have the capability for capturing the signal of the above power signal specification, and the second control unit 211 should have the capability for analyzing the signal of the above power signal specification.

In order to reduce the occupation space of the elements, the management module 11 a may be combined on the power supply controller 14 in a software or hardware form in design. Similarly, the response module 21a may also be combined on the power obtaining controller 24 in a software or hardware form in design.

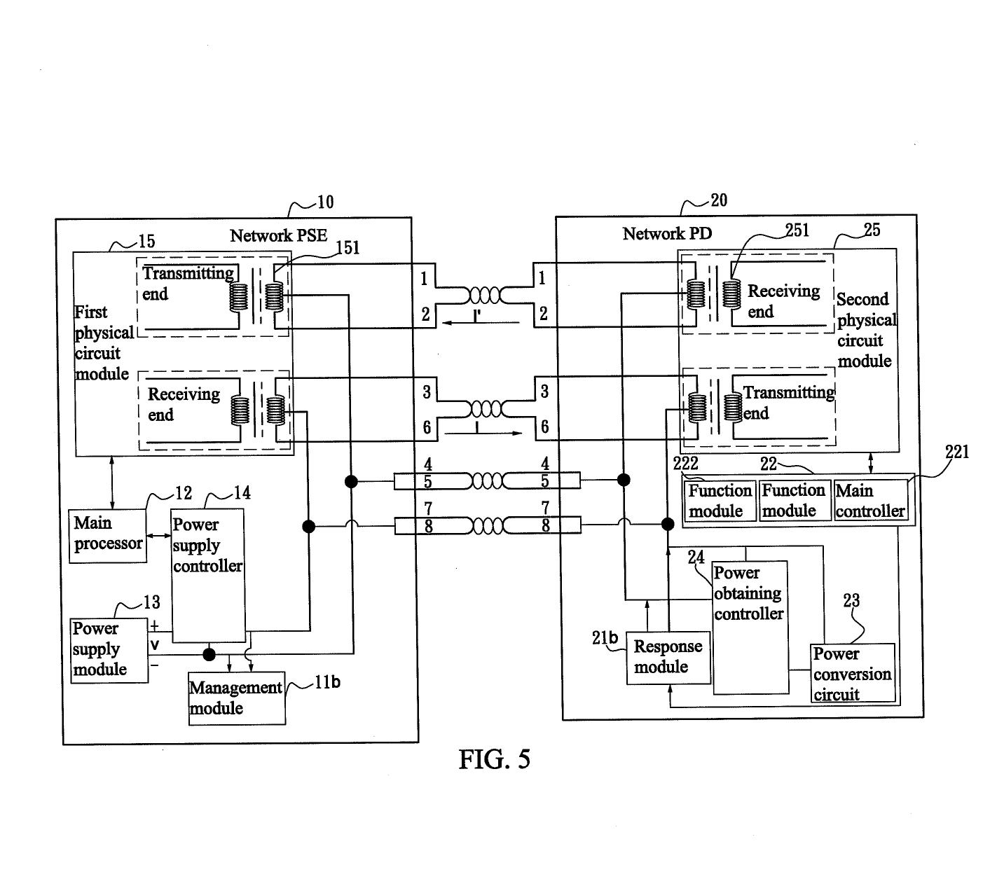

FIG. 5 is a second schematic system block diagram of a network power supply system according to an embodiment of the present invention.

The management module 11b is electrically connected to a line between the power supply controller 14 and the first physical circuit module 15. The response module 21b is also electrically connected to a line between the power obtaining controller 24 and the second physical circuit module 25. Herein, the management module 11b electrically connected to the power conversion circuit 23 in parallel is taken as example. In this embodiment, the management module 11b has a capability of a signal analyzer. The response module 21b has a capability of a signal generator.

The transmission of a power signal I between the network power supply equipment 10 and the network power device 20 is as shown in FIG. 5. For ease of description, the current transmission from the network power device 20 to the network power supply equipment 10 is temporarily referred to as a return power signal I′.

When the response module 21b is started, the response module 21b detects the state of the load circuit 22, generates an operating signal according to the operation of the load circuit 22, and combines the operating signal with the return power signal I′. The return power signal I′ is transferred to the network power supply equipment 10 through a network cable connected to the network power device 20.

The management module 11b is used for analyzing the return power signal obtained by the network power supply module, and extracting the operating signal. The operating signal is analyzed by the main processor 12 for performing a corresponding control mechanism, or is displayed by a display interface of the network power supply equipment 10 or a display interface connected externally for reference by managers.

However, furthermore, the response module 21b may also detect the load circuit 22 when it is determined that the load circuit 22 is abnormal after detecting the state of the load circuit 22. Alternatively, the response module 21b resets the network power device 20, or generates another operating signal to control the operation of the network power device 20. But the present invention is not limited to the technologies above, and the technologies that are applicable in the built-in mechanism of the PoE system technologies and are well known in the field of PoE system technologies can be used.

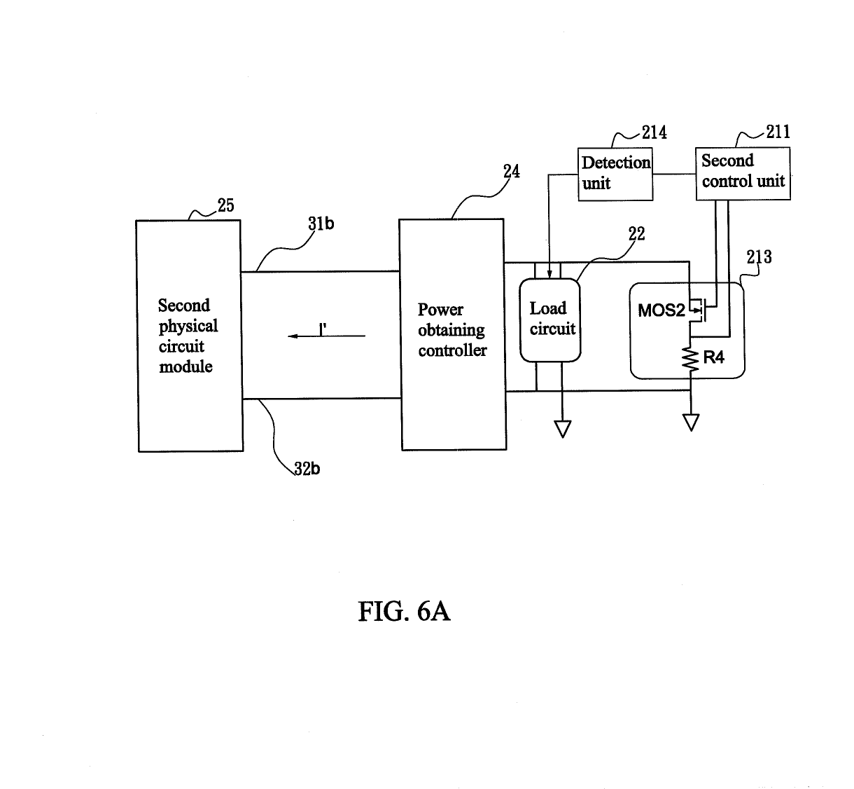

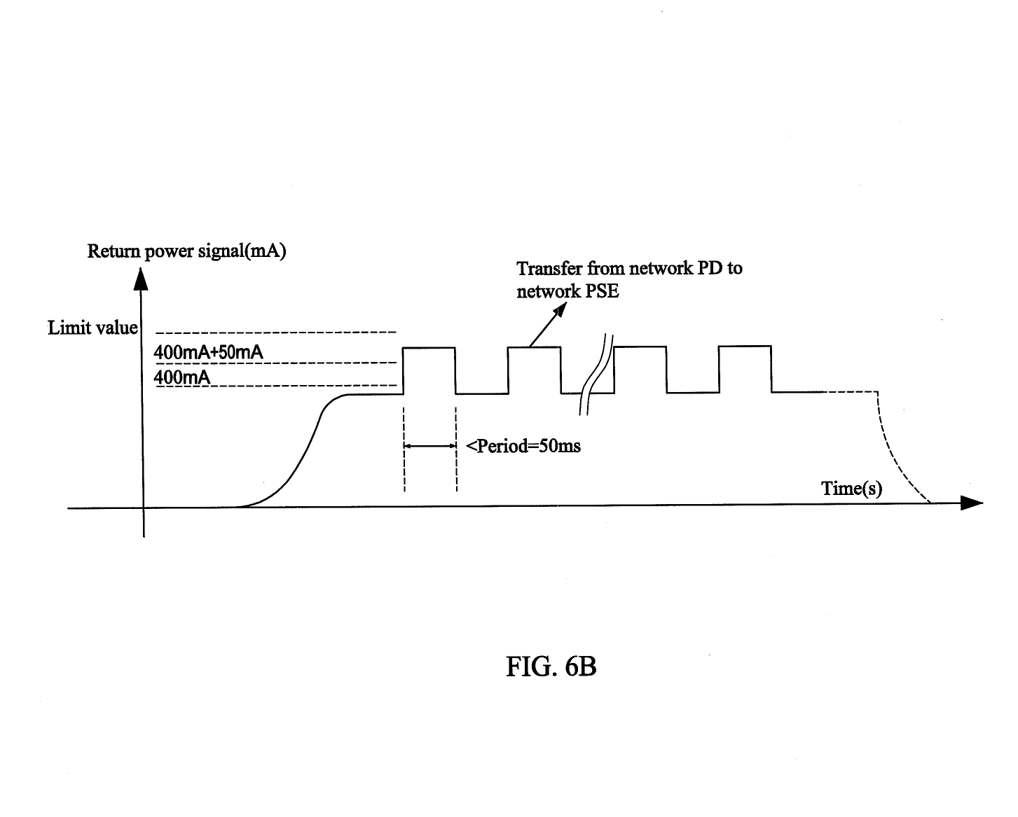

FIG. 6A is a partial equivalent circuit diagram of a second network power device 20 of a network power supply system according to an embodiment of the present invention. FIG. 6B is a schematic view of a return power signal of a network power supply system according to an embodiment of the present invention. For ease of understanding, reference can be made to the second system block diagram in FIG. 5. The power obtaining controller 24 is also connected to the transmission transformers 251 of the second physical circuit module 25 through a positive line 31b and a negative line 32b.

The response module 21b includes a second control unit 211, a signal generation unit 213 and a detection unit 214. The detection unit 214 is electrically connected to the load circuit 22 and the second control unit 211, and is used for generating corresponding changes in the current according to the operation of the load circuit 22. The second control unit 211 is electrically connected to the signal generation unit 213 and the detection unit 214, and is used for sensing the operation of the load circuit 22, for example, the operation of the sense function module 222, according to the changes in the current, or detecting the content of signals output by the main controller 221, and controlling the signal generation unit 213 to generate a corresponding operating signal.

The second control unit 211 may be an MPU, an MCU, or other relevant types of computing or control elements. The signal generation unit 213 is, but not limited to, a circuit formed by a second field effect transistor MOS2 and a fourth resistor R4 connected in series, and other relevant types of detection circuits may also be used. A gate of the second field effect transistor MOS2 is connected to the second control unit 211, and is controlled by the second control unit 211 to turn on or off the signal generation unit 213. The second control unit 211 controls the signal generation unit 213 to generate an operating signal according to the changes in the current, and combines the operating signal with the return power signal. Herein, the situation that the operating signal is a signal having changes at a current level is taken as example, and the changes at the current level is set to be about 50 mini Ampere (mA). 0 corresponds to a low voltage of the voltage level, and 1 corresponds to a high voltage of the voltage level. Alternatively, 0 corresponds to a high voltage of the voltage level, and 1 corresponds to a low voltage of the voltage level, which depends on the demands of the designer. However, for the voltage and the current when the operating signal and the return power signal are being combined, the maximal values and the minimal values need to meet the specification of IEEE-802.3 or the specification range agreed by the equipments at two ends of the network cable.

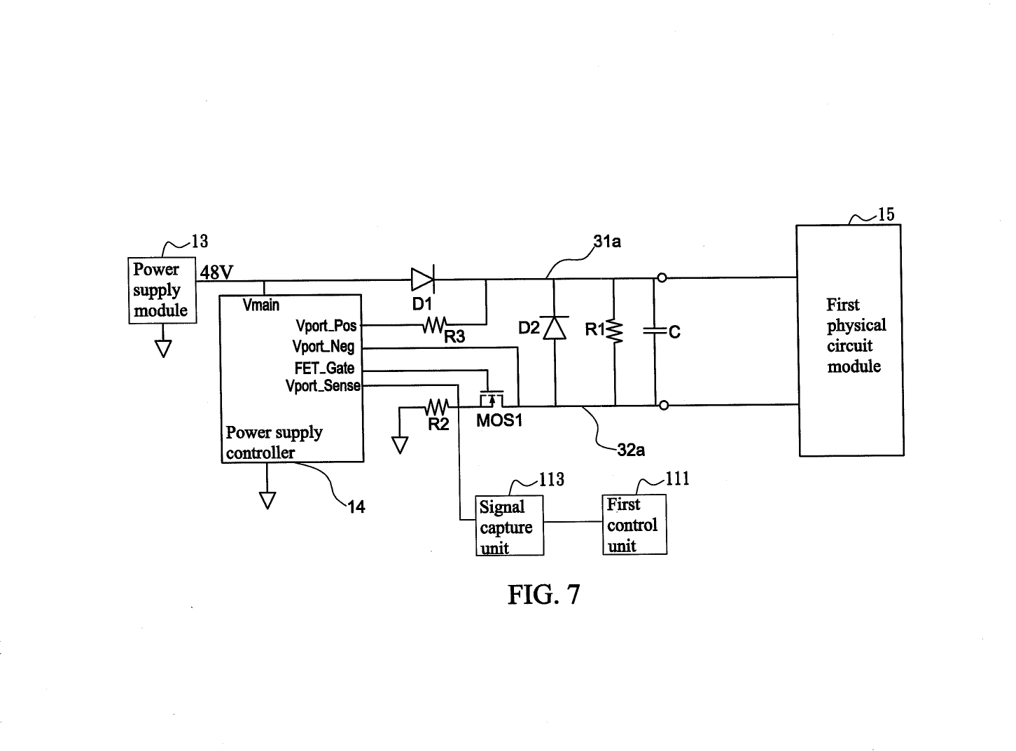

FIG. 7 is a partial equivalent circuit diagram of a second network power supply equipment of a network power supply system according to an embodiment of the present invention. For ease of understanding, reference can be made to the system block diagram in FIG. 5. In this embodiment, AC_Disconnect is taken as an example, but the present invention is not limited thereto.

The management module 11b includes a first control unit 111 and a signal capture unit 113. Herein, the signal capture unit 113 is electrically connected to the second resistor R2, and senses changes in the voltage of the second resistor R2, and extracts the return power signal I′. The first control unit 111 analyzes the changes at the current level of the return power signal I′ (as described above, 0 corresponds to a low voltage of the voltage level, and 1 corresponds to a high voltage of the voltage level; alternatively, 0 corresponds to a high voltage of the voltage level, and 1 corresponds to a low voltage of the voltage level), and extracts the operating signal. However, during analysis of the return power signal I′, if the return power signal I′ carries the operating signal in the form of changes at the current level, the operating signal in the form of changes in the current level can be analyzed following I=V/R or more precise related algorithms.

However, the management module 11b herein is also applicable in the DC_Disconnect network power supply equipment 10 described above, and the arrangement and operation of the management module 11b are similar to those in FIG. 7 and will not be repeated herein.

Moreover, the system architecture as shown in FIG. 1 and the system architecture as shown in FIG. 5 can be implemented at the same time, which depends on the demands of the designer, but the present invention is not limited thereto.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network power supply control system applicable in a network power supply equipment and a network power device connected through a network cable, and the network power supply control system comprising:
a signal generator for generating an operating signal to combine with a power signal transferred through the network cable; and
a signal analyzer for analyzing the power signal through the network cable to extract the operating signal.

2. The network power supply control system of claim 1, wherein the signal generator is disposed in the network power supply device and obtains the power signal of the network power supply module to generate the operating signal having rising and dropping changes at a signal level.

3. The network power supply control system of claim 2, wherein the signal analyzer is disposed in the network power device and comprises a signal capture unit and a control circuit connected to the signal capture unit and the load circuit, the signal capture unit is used for capturing the power signal obtained by the network power obtaining module; and the control unit is used to analyze the power signal, extract the operating signal, and controls the load circuit according to the operating signal.

4. The network power supply control system of claim 1, wherein the signal generator is disposed in the network power device and obtains the power signal of the network power module to generate the operating signal having rising and dropping changes at a signal level.

5. The network power supply control system of claim 4, wherein the signal analyzer is disposed in the network power supply device and comprises a signal capture unit and a control unit connected to the signal capture unit; the signal capture unit is used to capture the power signal obtained by the network power supply module; and the control unit is used to analyze the power signal and to extract the operating signal.

6. The network power supply control system of claim 4, wherein the network power device comprises a load circuit, the signal generator is further used to determine whether or not to detect the load circuit after detecting the state of the load circuit.

7. The network power supply control system of claim 4, wherein the network power device comprises a load circuit, the signal generator is further used to determine whether or not to reset the network power device or generate another operating signal to control an operation of the network power device after detecting the state of the load circuit.

8. A network power supply equipment of a network power supply control system, comprising:
a network power supply module for providing a power signal; and
a signal generator that is connected to the network power supply module and generates the operating signal and combines the operating signal with the power signal.

9. The network power supply equipment of a network power supply control system of claim 8, wherein the signal generator comprises a control unit and a signal generation unit connected to the control unit, and the control unit is used to control the signal generation unit to generate the operating signal.

10. The network power supply equipment of a network power supply control system of claim 9, wherein the signal generation unit is a transistor or a relay, is used to obtain the power signal of the network power supply module, and is controlled by the control unit to form a closed path or an open path to generate the operating signal.

11. The network power supply control system of claim 8, wherein the signal generator obtains the power signal of the network power supply module to generate the operating signal having rising and dropping changes at a signal level.

12. A network power device connected to the network power supply equipment in claim 3, comprising:
a load circuit;
a network power obtaining module connected to a network power supply module through a network cable to obtain a power signal; and
a signal analyzer connected to the network power obtaining module and the load circuit, and said signal analyzer captures and analyzes the power signal extracts a operating signal from the power signal, and controls the load circuit according to the operating signal.

13. The network power device of claim 12, wherein
the signal analyzer comprises a signal capture unit and a control circuit connected to the signal capture unit and the load circuit;
the signal capture unit is used for capturing the power signal obtained by the network power obtaining module; and
the control unit is used to analyze the power signal, extract the operating signal, and controls the load circuit according to the operating signal.

14. A network power device of a network power supply control system, comprising:
a load circuit;
a network power obtaining module to provide a return power signal; and
a signal generator, connected to the network power obtaining module and the load circuit, for detecting a state of the load circuit to generate a operating signal such that the operating signal is combined with the return power signal.

15. The network power device of a network power supply control system of claim 14, wherein the signal generator comprises a control unit, and a signal generation unit and a detection unit connected to the control unit, the signal generation unit is connected to the network power obtaining module, the control unit is used for detecting the state of the load circuit through the detection unit, and controlling the signal generation unit to generate the operating signal and combining the operating signal with the return power signal.

16. The network power device of a network power supply control system of claim 14, wherein the signal generator is further used to determine whether or not to detect the load circuit after detecting the state of the load circuit.

17. The network power device of a network power supply control system of claim 14, wherein the signal generator is further used to determine whether or not to reset the network power device or generate another operating signal to control an operation of the network power device after detecting the state of the load circuit.

18. The network power supply control system of claim 14, wherein the signal analyzer generates the operating signal at a signal level.

19. A network power supply equipment connected to the network power device of claim 14, comprising:
a network power supply module, connected to the network power device through a network cable, that obtains a return power signal; and
a signal analyzer, connected to the network power supply module, that captures and analyzes the return power signal, and extracts a operating signal from in the return power signal.

20. The network power supply equipment of claim 19, wherein:
the signal analyzer comprises a signal capture unit and a control unit connected to the signal capture unit;
the signal capture unit is used to capture the return power signal obtained by the network power supply module; and
the control unit is used to analyze the return power signal and to extract the operating signal.
